(19) United States
(12) Patent Application Publication
(10) Pub. No.: US 2008/0141668 A1
(43) Pub. Date: Jun. 19, 2008

(54) Electrohydraulic drawing press cushion drive

(76) Inventor: Michael Micklisch, Goppingen (DE)

Correspondence Address: Ronald S. Lombard, 4430 Twin Oaks Drive, Murrysville, PA, 15668, US

(21) Appl. No.: 11/998,677

(22) Filed: Dec. 1, 2007

(30) Foreign Application Priority Data
Dec. 13, 2006 (DE) 10 2006 058 630.1

(51) Int. Cl. B21D 24/02; F16D 31/02

(52) U.S. Cl. 60/413; 60/417; 72/350

(57) ABSTRACT

In an electrohydraulic drawing press drive, particularly an electrohydraulic drawing cushion drive including a hydraulic circuit with at least one motor which is operable as a drive motor or as a pump and at least one hydraulic pump which is operable as a pump or as a drive motor, an electric drive motor which is also operable as generator is connected to the hydraulic motor in order to drive the hydraulic motor or to be driven thereby and a control unit is provided for controlling at least one of the electric motor and the hydraulic pump.

### CROSS-REFERENCE TO RELATED APPLICATION

This application claims the priority benefits of German Application No. 10 2006 058 630.1 filed Dec. 13, 2006.

### BACKGROUND OF THE INVENTION

The invention relates to an electrohydraulic press or auxiliary drive arrangement, particularly an electrohydraulic drawing cushion drive with energy recuperation.

Draw cushions are used in drawing presses to generate a force in a direction opposite the press plunger movement, for example, in order to engage, a metal sheet holder, the edges of a metal sheet subjected to the drawing operation in order to hold them in position during the drawing process. The metal sheet holding ring provided therefore has to withstand at least one drawing stroke. In connection with vehicle body metal parts such a drawing stroke may be very large, that is, it may be up to 300 mm or even more. Since, under such circumstances, the force required to hold the metal sheet in place, a correspondingly large amount of energy must be provided by the drawing cushion. With the common press operating speeds with drawing cushions or, respectively, the force generating means, power losses may occur in force generating devices in the area of 100 KW or even more.

It is generally desirable to control the force effective at the drawing cushions, and, furthermore, to recuperate the energy taken up by the drawing cushion.

DE 10 2005 026 818 A1 proposes to drive the drawing cushions by a direct electric drive, a so-called NC drive. These force or position controlled electric drives may be linear motors or rotating motors such as, for example, servo-motors.

DE 198 21 159 A1 proposed to drive the drawing cushion by means of servo-motors which are connected to the drawing cushion via spindle drives. Similarly, the publication also proposed to drive the plunger by means of a servo-motor and a spindle drive. The electric drives can be interconnected and be arranged in an energy exchange relationship.

It is the object of the present invention to provide an arrangement with which the drawing force to be generated can be better controlled and the possibility of energy regeneration is improved.

### SUMMARY OF THE INVENTION

In an electrohydraulic drawing press drive, particularly an electrohydraulic drawing cushion drive including a hydraulic circuit with at least one motor which is operable as a drive motor or as a pump, and at least one hydraulic pump which is operable as a pump or as a drive motor, an electric drive motor which is also operable as a generator is connected to the hydraulic motor in order to drive the hydraulic motor or to be driven thereby and a control unit is provided for controlling at least one of the electric motor and the hydraulic pump.

The drive arrangement according to the invention is considered to be used mainly in connection with drawing cushion drives. However, the advantages obtained thereby may also be fully or partially be obtained in connection with other auxiliary drive arrangements or in connection with main press drives.

The drive arrangement according to the invention includes a controllable electric motor which is also usable as generator and which drives to member to be driven, for example, a drawing cushion via a hydraulic drive. The hydraulic drive is preferably a hydrostatic drive wherein the electric motor is connected to a displacement pump. The hydraulic motor drive by the fluid pressurized in the displacement pump preferably also operates according to the displacement principle. The hydraulic motor may be, for example, a hydraulic cylinder. Preferably, this is then a double acting cylinder, that is, it has two operating chambers whose volumes change in an opposite sense, that is, one becomes smaller as the other becomes larger when the hydraulic piston is moved. The hydraulic drive may have several such hydraulic motors or respectively hydraulic cylinders. In place of the hydraulic cylinders also other hydraulic motors may be provided, such as gear motors or similar motors whose rotational movement can, when needed be converted to a linear movement via a mechanical drive arrangement.

The hydraulic motors travel during an operating stroke of the press over the distance over which the driven member has to move. For a drawing cushion drive, this is the full drawing stroke. As a result, the hydraulic motors transmit per press stroke on energy amount, which corresponds to the travel distance, integral of the applied force for the full travel distance. The hydraulic circuit of the hydraulic transmission transmits this energy to the electric motor. The hydraulic pump operates in this case as a hydraulic motor. It is operated so-to-speak in reverse. The elective motor operates as a generator and feeds the energy taken up by the drawing cushion back into the power grid or transfers it to a separate energy storage device and/or another consumer.

The electrohydraulic drive principle for the drawing cushion has several advantages. It permits energy recuperation which results in a high operating efficiency. In addition, the losses unavoidable in the energy regeneration are minimized. Furthermore, well proven components, such as, hydraulic pumps, hydraulic motors, etc. can be used which results in a robust reliable system. Furthermore, the rigidity of the hydraulic system can be set in a targeted manner. If desired, it is therefore, possible to provide for a certain dumping between the drawing cushions and the electric motor. In addition, overload safety measures can easily be integrated. They may be, for example, in the form of oven pressure valves in the hydraulic drive.

The system is suitable for supplementary installation. For example, the hydraulic cylinders normally present in connection with drawing cushions can be used as hydraulic motors. There are little installation expenses. Furthermore, the control of the arrangement is relatively simple.

Although conventional hydraulic drawing cushions have high energy losses, they have high control dynamics. That is, the drawing forces can be changed very rapidly simply by adjustment of the throttle valves. In mechanical servo-drives of drawing cushions, such high dynamics can not be achieved because of the necessary acceleration and deceleration of the service motors. They, however, permit an energy recuperation. The concept according to the present invention combines the advantages of both solutions in that, on one hand, at least if additional control valves are provided in the hydraulic circuit, the high control dynamics of conventional drawing cushions can be achieved and, on the other hand, energy recuperation is possible.

Furthermore, any play between the drawing cushion and the electric motor is omitted. If, for example, the drawing cushion is to be pre-accelerated in the plunger direction shortly before the plunger or, respectively, top tool part contacts the sheet metal to be deformed, in order to cause engagement of the top tool part with the sheet metal with only a relatively small impact, the electric motor has a drive function. As soon as the top tool part comes in contact with the sheet metal, it begins to push the drawing cushion downwardly. The electric motor reverses its direction of rotation. It operates now as a generator and brakes the drawing cushion. With the torque reversal, no plays are encountered as it is the case, for example, with spindle drives. This substantially improves the mechanical behavior and the controllability of the drive arrangement.

Particulars of advantageous embodiments of the invention will become apparent from the following description on the basis of the accompanying drawings. The description of the figures explains certain aspects for a better understanding of the invention. The description refers to particular embodiments of the invention. Variations are possible.

### BRIEF DESCRIPTION OF THE DRAWINGS

FIG. 1 shows a press with an electrohydraulic drawing cushion in a schematic representation;

FIG. 2 is a schematic simplified representation of the drawing cushion drive arrangement;

FIG. 3 is a schematic representation of a modified embodiment of the electrohydraulic drive arrangement;

FIG. 4 is a schematic simplified representation of a further modified embodiment of the electro hydraulic drive arrangement; and,

FIG. 5 shows diagram of the force applied to the drawing cushion by the electrohydraulic drive arrangement.

### DESCRIPTION OF THE PREFERRED EMBODIMENTS

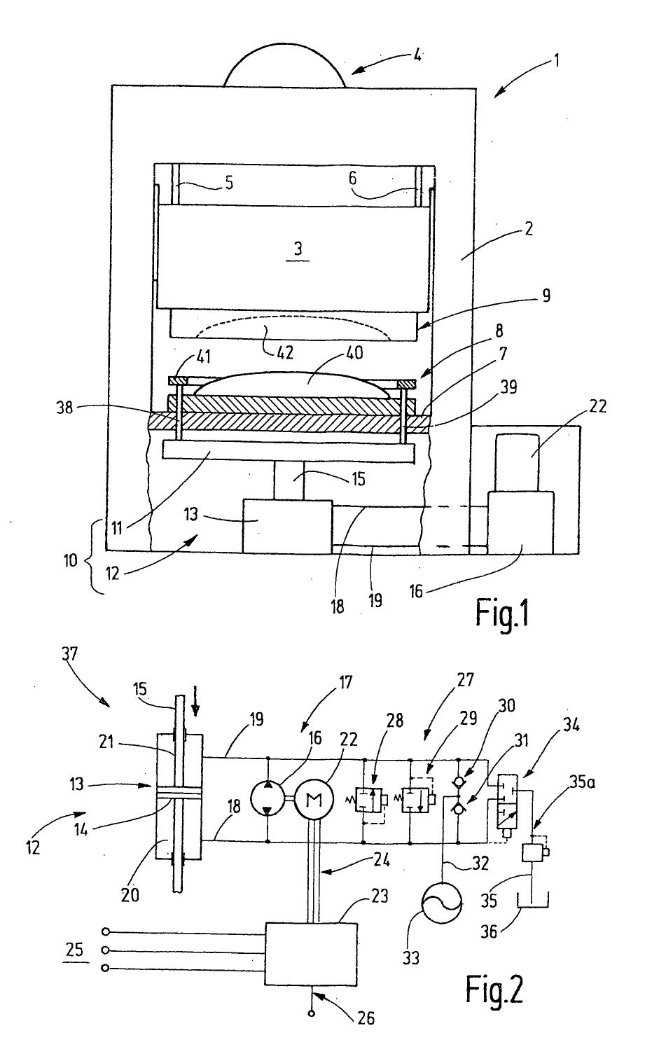

FIG. 1 shows schematically a press 1. It includes a press frame 2 with a plunger 3 preferably vertically movably supported thereby. The plunger 3 provided with, as shown in the embodiment, conventional main press drive 4 which drives the plunger 3, for example via a mechanical drive which is not shown in detail, but which includes an eccentric member and a crank 5, 6.

Opposite the plunger 3, in this case below the plunger 3, a press table 7 is arranged on which the bottom tool part 8 is disposed. The plunger 3 curves the respective top tool part 9.

Below the press table 7, the drawing cushion 10 is arranged which includes a floating plate 11 and at least one hydraulic motor 12. The hydraulic motor is formed by at least one (or several) hydraulic cylinder 13, whose piston 14 is connected to the floating plate 11 by a piston rod 15. The hydraulic motor 12 is part of a hydraulic drive which includes a pump 16. In this hydraulic circuit 17 shown in FIG. 2, the pump 16 is connected to the hydraulic cylinder 13 by way of two lines 18, 19.

In the double acting hydraulic cylinder 13, the piston 14 has two operating chambers 20, 21 are separated by the piston 14 and their volumes are increased or respectively, reduced with the movement of the piston 14. The operating chamber 20 is connected to a connection of the pump 16 via a line 18. The operating chamber 21 is connected via the line 19 with other connection of the pump 16. The pump 16 can pump in both directions, that is, from the line 18 to the line 19 and from the line 19 to the line 18. The pump is preferably a displacement pump, for example, a gear pump. It can operate as a pump wherein it is operated by an associated electric motor. Vice-versa, it can also operate as a hydraulic motor which is driven by the hydraulic fluid present in the hydraulic circuit 17 wherein it then drives the motor 22 which, in this case, is operating as an electric generator.

The electric motor 22 is, for example, a position controlled electric motor. It can be connected to angle sensors which are not shown, for example, resolvers or similar devices which sense its angular position and supply it to a control unit 23. The control unit 23 is connected to the electric motor 22 via lines 24, in order to supply a voltage or current to the electric motor 22 and to control it in a targeted manner. The electric motor may be position controlled or force-controlled or power controlled depending on the requirements. If desired, it may be switchable between the operating modes mentioned. The control unit 23 may be so designed that the switching can occur during a press stroke once or several times in an abrupt manner or slidingly.

The control unit 23 is connected to an electric power supply 25 from which it withdraws energy for the operation of the motor 22. The control unit 23 is particularly capable to feed energy generated by motor 22 when operated as a generator back into the electric power supply system via the power supply system this electric energy can then be supplied to other loads, for example, the main press drive 4.

The energy can also be transferred from the control arrangement 23 to other loads or consumers in by passing the power supply system 25, for example, by way of a DC voltage intermediate circuit or other suitable means. To this end, the control arrangement 23 may include at least one or several additional connections 26.

The hydraulic circuit preferably includes an overload safety device 27, as shown, in FIG. 2. In this way, an overload and damage of components of the drawing arrangement or, respectively of the corresponding drive arrangement can be avoided. The overload protection device 27 may include one or more excess pressure relief valves 28, 29 which open by-pass channel between the line 18 and the line 19 when the differential pressure between the two lines exceeds a maximum value. In addition, the two lines 18, 19 can be in communication with each other via oppositely oriented check valves 30, 31 between which a line 32 branches off which extends to a pressure storage device 33. In this way, upon opening of one of the excess-pressure valves 28, 29 the pressure as present in the pressure storage device 33 is maintained in the respective operating chamber 20 or 21, so that a minimum counter-force is effective on the floating plate 11.

In addition, a multi-path valve 34 may be connected to the lines 18, 19 which is controlled, for example, by the pressure in the line 18. It may be so designed that, in the case of excess pressure, it opens a channel 35 which extends to an oil collection tank 36. In the channel 35 an over-pressure 35a may be arranged, if desired.

The components described so far in FIG. 2, which are partially optional, form a drive arrangement 37 for the floating plate 11. The drive arrangement 37 comprises at least the hydraulic motor 12, the pump 16, the motor 22 and the control arrangement 23 as well as the various connecting lines.

The floating plate 11 is arranged below the lower tool part 8, by way of openings in the press table 7 or, respectively, the lower tool part 8, the pressure pins 38, 39 extent toward the plunger 3. The pressure pins 38, 39 are arranged along the circumference of a molding tool part 40. They carry a sheet metal retaining ring 41, which is pressed downwardly by the upper tool part 9 driving the drawing operation. The drive arrangement 37 generates the counterforce needed for clamping and retaining a sheet metal between the sheet metal retaining ring 41 and the upper tool part 9.

The press 1 described, so far, operates as follows:

during operation, a sheet metal part is placed onto the sheet metal retaining ring 41 and the tool is then closed as the plunger 3 is moved downwardly by the main press drive 4. In the most simple case, the top tool part 9 then engages the sheet metal part and clamps and firmly holds the circumference thereof; subsequently, upon further downward movement of the plunger 3, the sheet metal and the sheet metal retaining ring 41 are forced downwardly. The molding tool part 40 which is complementary in shape to a mold recess 42 in the top tool part 9, however, remains stationary. As a result, the sheet metal part is drawn over the molding tool part 40. The sheet metal retaining ring 41 is pressed against the top tool part 9 with a controlled force. This is achieved in that the hydraulic cylinder 13 inhibits the downward movement of the floating plate 11, which supports the sheet metal retaining ring 41 via the support pins 38, 39. The downward movement of the floating plate 11 is inhibited as the piston 14 moving downwardly together with the piston rod 15 causes the operating chamber 20 to become smaller and operating chamber 21 to become larger. As a result hydraulic fluid, such as oil displaced from the chamber 20 via the line 18 and the pump 16 and the line 19 into the operating chamber 21. In the process, the hydraulic fluid drives the displacement element of the pump 16 comprising one or several gears. The displacement element is firmly connected to the electric motor 22 for rotation therewith, so that the electric motor 16 is driven by the displace element of the pump 16. The control arrangement 23 controls, via the energization of the windings of the electric motor 22, the canister force provided by the motor. From the view of the pump 16, the electric motor 22 acts as a brake. It operates as a generator and feeds energy via the lines 24 and the control arrangement 23 either back to the power supply 25 or via the connection 26 to other consumers. The control arrangement can actively control the counter-force provided by the elective motor 22. This counter force corresponds to the force effective at the floating plate 11 and consequently at the metal sheet support ring 41 with a fixed transmission ratio.

The motor 22 herein converts the whole energy which has been transmitted by the plunger 3 to the metal sheet support or retaining ring 41. This energy corresponds to the travel distance integral of the force acting on the floating plate 11 over the whole drawing length.

Consequently, the drive arrangement 37 according to the invention provides on one hand for a highly sensitive position-dependent control of the metal sheet retaining force and, on the other hand for energy recuperation. The hydraulic transmission 17, which provides in the present case for a fixed transmission ratio operates at the same time as a buffer and is free of any play.

In case of overload, for example, in connection with a rapid load change or as a result of a fault or another unforeseeable occurrence, the overload safety device 27 may be activated. For example, the valve 34 may open and, for example, release oil displaced from the operating chamber 20, which can not be accommodated by the pump 16 without unacceptable pressure increase.

Also, in a less grave situation, with an overload of the pump 16 the overpressure valve 28 or the overpressure valve 29 may open so as to establish communication with the pressure storage device 33, which then generates a certain canister pressure. Load peaks are avoided in this way.

After the drawing procedure, the electric motor can be controlled in such a say that the sheet metal retaining ring 41 is returned from its lower position back to its upper position. At the same time also, the workpiece may be moved upwardly so that it can be better removed from the transfer arrangement.

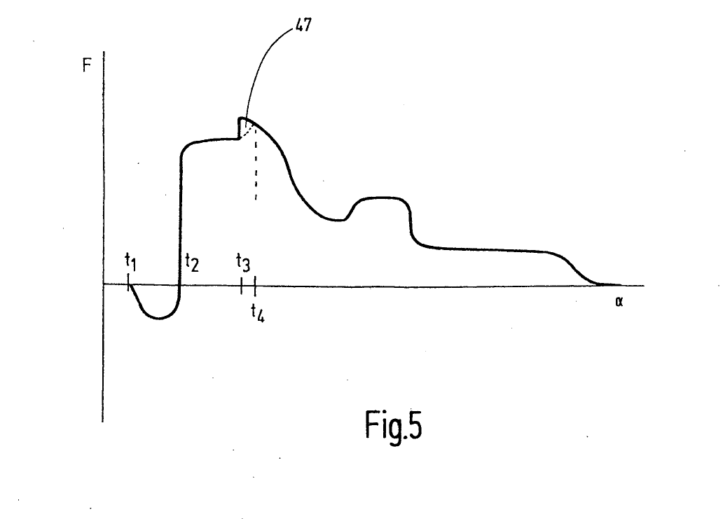

In the description of the operation provided above, it is assumed for simplicity reasons that the upper tool part 9 engages a metal sheet which is resting on the sheet metal support ring 41. But, using the drive arrangement 37, a predetermined, pre-acceleration of the support ring 41 can be achieved in order to dampen the impulse of the engagement of the upper tool part 9 with the sheet metal. This is, for example, apparent from FIG. 5. This figure shows an arbitrary course of the force applied by the hydraulic motor 12 dependent on the press-angle α. At this time, t₁ before the engagement of the upper tool 9 with the sheet metal, the sheet metal support ring 41 is to be accelerated downwardly. In this case, the support ring 41 is first disposed somewhat above the molding tool part 40 that is higher than shown in FIG. 1. Then the operating chamber 21 must be pressurized. As a result, a downwardly directed force is effective on the floating plate 11 as indicated in FIG. 5. The electric motor 22 then drives the pump 16 providing for hydraulic fluid under pressure by which the hydraulic motor 12 is driven. At this point in time, t₂ the upper tool part 9 carries into contact with the sheet metal and braces the sheet metal support ring 41 and consequently the floating plate 11 downwardly. The hydraulic motor now has to generate, without delay, a high counter force. As a result, the electric motor 22 instantly converts to generator operation. The force F reverses its direction and suddenly increases. From here on, the control arrangement 23 can be controlled depending on the press angle or depending on travel sensors which monitor the position of the sheet metal support ring 41 and/or the floating plate 11 and/or the hydraulic cylinder 13 and/or the position of the electric motor 22.

While the electric motor is again position controlled, it can operate in the subsequent braking phase, for example, force-controlled. But other kinds of operation are also possible.

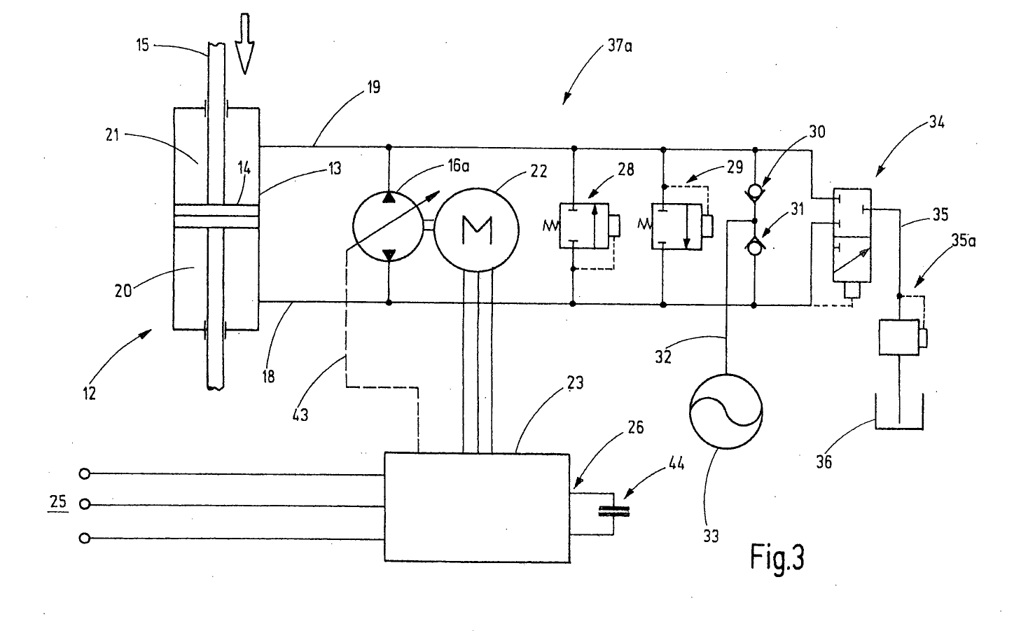

FIG. 3 shows a modified embodiment of the invention. To the extent there is a conformity with the embodiment described above, reference is made to the above description based on the use of identical reference numerals. Different from the above embodiment, however, the drive arrangement 37 as shown in FIG. 3, includes a hydraulic pump 16a with a controllable pumping volume. This is a so-called control-pump, for example, a controllable axial piston pump. It can provide different pump volumes at a given speed. The pump is controlled by way of a control line 43, for example, by the control unit 23. The use of the pump 16a with controllable pumping volume is advantageous particularly when the sheet metal support ring 41 needs to be pre-accelerated as described above. There is then no need for the otherwise necessary rapid acceleration of the electric motor 22 and the pump 16 at the beginning of the pre-acceleration. The dynamics of the drive arrangement 37a are improved over the dynamics of the drive arrangement 37.

An additional or alternative variation of the drive arrangement 37a resides in the provision of an energy storage device 44, for example, in the form of a condenser packet, a fly wheel storage unit or another energy storage device 44 which is connected to the connection 26. The energy storage device 44 makes it possible to avoid a high electric-power supply load resulting from a short-term feedback storage of large amounts of energy into the electric power grid 25. It can be used to equalize the feed back storage energy. That is the energy released during the drawing stroke can be supplied to an intermediate storage device and then returned to the power grid in a uniform way. Furthermore, it is alternatively or additionally possible to connect other loads or energy consumers directly to the energy storage device 44 so that the intermediately stored electric energy can be supplied directly to other consumers while by-passing the power grid.

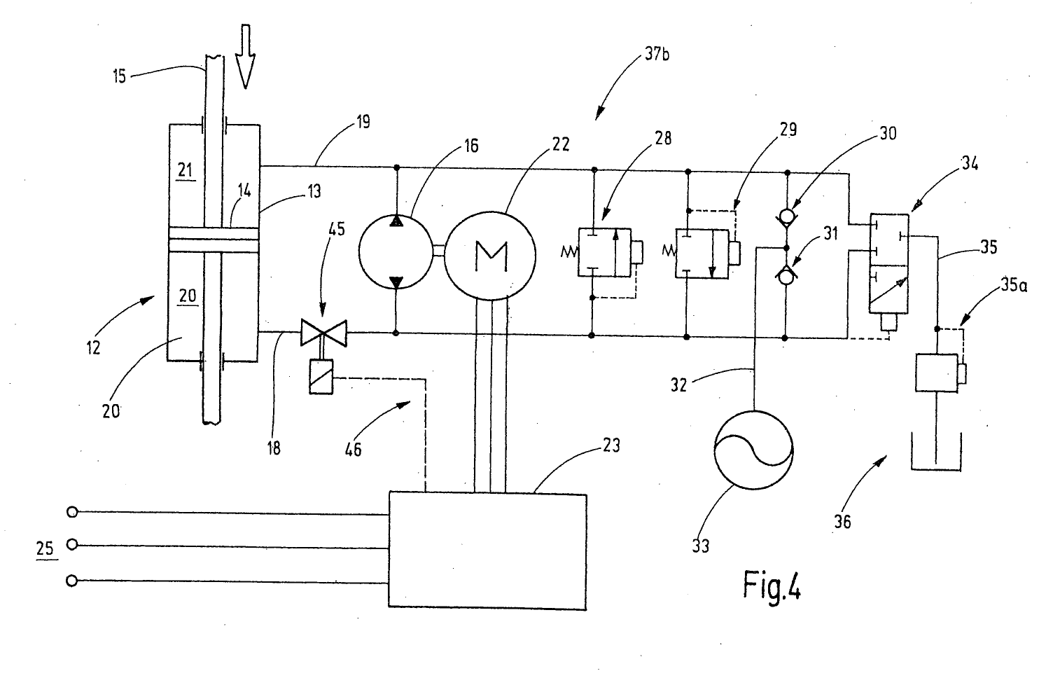

Another embodiment of the drive arrangement 37b is shown in FIG. 4. As far as this embodiment coincides with the previously described embodiments the identical reference numerals are used without further explanations. The earlier descriptions are applicable also in this case. The changes that will be described below may also be applicable in connection with the systems described earlier.

For further improved dynamics, the drive arrangement 37b includes a proportional valve 45 which is arranged between the pump 16 and the hydraulic motor 12 as, respectively, the hydraulic cylinder 13. For example, the proportional valve 45 may be arranged in the line 18, which connects the operating chamber 20, which becomes smaller during the downward movement of the floating plate 11, with the pump 16. The proportional valve is preferably connected to the control unit 23 via an activator and a symbolically shown control line 46. The proportional valve 45 is particularly advantageous when the desired drawing force curve includes jumps. In FIG. 5, at this point in time t₃ an arbitrary jump-like force increase is shown, which for example occurs with a sudden speed increase and which can not be provided so rapidly by an electric motor. This force increase, however, can be achieved by a rapid change of the position of the proportional valve 45 providing for an increased throttling. For a short period, an energy loss occurs at the proportional valve 45 in such a case. However, as soon as the pump 16 and the electric motor 22 have adjusted their speed and have taken over the generation of the canister pressure the proportional valve can again be operated. This is the case in FIG. 5, for example, at the point in time t₄. The canister-pressure build-up of the pump 16 is shown as a pointed line. Only a relatively small amount of energy 47 is lost at the proportional valve 45. The energy amount 47 corresponds to the area between the pointed line and the heavy lined curve.

In the arrangement according to the present invention, the drawing cushion is operated via a hydraulic, possibly controllable motor/pump combination which is directly coupled to a possibly controllable electric motor/generator. One revolution of the electric motor corresponds to a particular travel distance of the hydraulic motor that is the hydraulic cylinder. The system includes an electric motor and a generator mode of operation. In the electric motor mode of operation, the speed of the cylinder-piston is controlled by a speed control of the electric motor and/or a change of the pumping volume or the pumping pressure of the pump. A reversal of the direction of rotation of the electric motor or a reversal of the pumping direction of the hydraulic pump results in a reversal of the direction of operation of the hydraulic cylinder. This type of operation may also be used, for example, in the upward movement of the metal sheet support ring, the pre-acceleration thereof, the pull back thereof or for the ejection of pressed parts. The generator type of operation is provided for the energy regeneration during the drawing procedures.

During operation with a pump having an adjustable pumping volume and/or an adjustable pumping pressure and/or a controllable pumping direction, for example, a so-called cone pump, the engagement force and/or a direction reversal of the drawing cushion can be achieved by a control of the pump. The speed and/or the direction of rotation of the electric motor may remain constant. By keeping the speed of the electric motor constant, the moment of inertia of the electric motor can be uncoupled from the drawing cushion. Consequently, the forces on the drawing cushion can be changed especially fast. The controllability can therefore be achieved without limits in spite of the energy recuperation.

What is claimed is:

1. An electrohydraulic drawing press drive, particularly an electrohydraulic drawing cushion drive, comprising:
a hydraulic circuit (17) including at least a hydraulic motor (12) which is operable as a drive motor or as a pump and at least one hydraulic pump (16, 16a) which is operable as a pump and as a drive motor;
an electric motor (22) which is also operable as a generator and which is connected to the hydraulic motor (12) in order to drive the hydraulic motor (12) or to be driven thereby; and,
a control unit (23) for controlling at least one of the electric motor (22) and the hydraulic pump (16).

2. The press drive as claimed in claim 1, wherein the hydraulic motor (12) is a hydraulic cylinder (13).

3. The press drive as claimed in claim 1, wherein the hydraulic circuit (17) includes an overload safety device (27).

4. The press drive, as claimed in claim 1, wherein the pump (16) is a constant volume pump.

5. The press drive, as claimed in claim 1, wherein the pump (16a) is a controllable pump.

6. The press drive, as claimed in claim 1, wherein the hydraulic motor (12) and the pump (16, 16a) are directly coupled via hydraulic lines.

7. The press drive, as claimed in claim 1, wherein the hydraulic motor (12) and the pump (16) are coupled via a proportional valve (45).

8. The press drive, as claimed in claim 1, wherein the electric motor (22) is connected via a control unit (23) to a power supply grid (25) which supplies electric energy and is capable of accepting recuperated electric energy.

9. The press drive, as claimed in claim 1, wherein the electric motor (22) is connected via the control unit (23) to an energy supply grid (25) and also to an energy storage device (44).

10. The press drive, as claimed in claim 1, further comprising a floating plate (11) connected to the hydraulic motor (12), a drawing cushion (10) is arranged which includes the floating plate (11) and the hydraulic motor (12).
